(19) United States
(12) Patent Application Publication
(10) Pub. No.: US 2012/0201589 A1
(43) Pub. Date: Aug. 9, 2012

(54) INTERFACE FOR A COMPUTER

(76) Inventor: Rachel VAN BUREN, Ramat Gan (IL)

(21) Appl. No.: 13/358,589

(22) Filed: Jan. 26, 2012

(30) Foreign Application Priority Data
Jan. 27, 2011 (IL) 210917

(51) Int. Cl. B41J 5/30

(52) U.S. Cl. 400/490

(57) ABSTRACT

An interface for retrofitting to a portable computer such as a notebook or laptop computer, the interface for covering the keyboard and having a plurality of jumbo buttons, each jumbo button for covering more than one key of the keyboard.

### FIELD OF THE INVENTION

The present invention is directed to providing a device and method for inputting data into a computer that is particularly appropriate for use by users with poor coordination, such as young children, the arthritic elderly and the handicapped, for example.

### BACKGROUND OF THE INVENTION

The home computer is a general purpose device that serves different family members in different ways. Young children can learn shapes, colors, counting and other basic skills, and there is a plethora of computer applications and specially designed interfaces for this market segment.

The severely physically handicapped can interact with the outside world via the computer. By depressing keys using a probe attached to the head, quadriplegics have managed to write poetry and type up their autobiographies.

The standard QWERTY array has about 50 keys. Computer keyboards include the QWERTY keypad, an alphanumeric keypad, cursor control keys, editing keys such as INSERT, DELETE, ALT, TAB, navigational keys such as page up, page down, print screen and various function keys. Generally, computer keyboards have over a hundred keys. Such a large number of keys is distracting and confusing to both children and the handicapped.

Special keyboards designed for children are known. Such keyboards tend to have a small number of large, easily depressed keys. They may be connected to the computer instead of to the standard keyboard, or may plug in to one or other of the peripheral ports, such as in place of the printer, for example. However, any keyboard that is connected and disconnected from a computer by plugging it into a computer port and removing it therefrom regularly, tends to have a short life expectancy. Pins get bent, particularly when a child takes the initiative to plug his/her keyboard in. Any peripheral designed for children will tend to be regarded as being a toy. Electronic equipment and children are not really compatible. Food and drink ruin keyboards. In short, special children's keyboards have had limited success.

Another approach is described in Canadian Patent No. 2,194,317 to Fisher Price™ which describes a computer keyboard to aid child users, that sits on a regular keyboard. The Fisher Price™ keyboard covers and blocks out individual blocks of keys, such as the numeric keypad or the function keys to display a reduced selection of keys to the child. However, the buttons to be depressed by child are regular sized keys for adult users.

Blocking out keys or blocks of keys is not new. U.S. Pat. No. 5,348,405 entitled “Computer keyboard key depression inhibitor device” describes a key depression inhibitor device for a computer keyboard which is intended to prevent accidental or inadvertent manual depression of a certain key or combination of keys on a computer keyboard. The device has top, side and end walls which form a generally hollow cover adapted to fit over a single key or over certain combinations of keys in the “F” key section, the page control key section and/or the cursor control key section of a computer keyboard. The device is constructed to fit snugly over the key or combination of keys which it is intended to cover and to be readily removable therefrom, so that it can be installed and removed at will.

United States Patent Number U.S. Pat. No. 5,193,924 to Larson, entitled “Cap cover for keyboard keys” describes a cap cover for keyboard keys for use with a computer or cash register. The capcover is essentially a hollow box adapted to rest on base or grid plate. The cap cover prevents keys that are covered thereby from being depressed.

WO 9400809 entitled “Keyboard Cover”, describes a keyboard cover which allows the keys of a keyboard to be used. The cover includes portions which correspond to the faces of the keys. Inserts are attachable to the portions so as to cover markings on the faces of the keys. The inserts are adapted to include markings which are a substitute for the markings on the faces. Alternatively, the portions themselves may include markings which cover and are a substitute for the markings on the faces of the keys.

There are a number of patents that cover the keys of a regular keyboard with keys that are tactile for Braille readers, e.g. U.S. Pat. No. 5,536,170, or which provide lower case letters instead of upper case letters, or which change the alphabets shown on keys to enable use of the keyboard for typing in a different language.

Published US application number US2001/004108 to Lebeau describes disposable plastic covers for keyboards for use in laboratories and the like. These will protect the keys, and allow each key to be individually depressible.

Published US application number US2003/0206153A1 entitled “Keycap for displaying a plurality of indicia” relates to a key cap for use with the keyboard of a computer. The key cap has a support structure which is larger in size than the activation keys and is adapted to display indicia read by the individual. The keycap is used to display a plurality of indicia, such as Braille, pictures, etc., for use with a keyboard that interacts with an electronic device, such as a computer. The keycap includes at least one engagement member, for removably engaging with at least one activation key on a keyboard, and at least a first support structure for displaying the indicia. The first support structure is larger in at least one direction than the activation key and allows the keycap to display the indicia in a sufficiently large size to allow the keycap to display, for example, phrases, sentences, musical notation, mathematical expressions, etc. This feature allows the keycap to be compatible with a large number of software programs used to teach, for example, disabled individuals. The keycap preferably is used with a removable overlay containing the plurality of indicia that allows the keycap to be easily configured to the user's needs or the requirements of the software program. The keycap includes at least one attachment member to removably attach the overlay to the keycap. The attachment member preferably comprises two channels disposed on opposite ends of the first support structure and a second support structure which is adapted to slidably engage with the two channels to hold the overlay immobile between the first and second support structures.

U.S. Pat. No. 6,310,608 to Kaply et al. entitled “System and method of keyboard configuration for disabled user access” relates to a computer system for disabled users and groups keys into a compound key corresponding to a specified command. Essentially a system and method for grouping together multiple keys on a keyboard to form compound keys is presented. An exemplary configuration of compound keys described therein involves grouping function keys “F1” through “F4” together to form one key, grouping function keys “F5” through “F8” to form a second key, and grouping function keys “F9” through “F12” to form a third key. In such an embodiment, actuating any of the keys “F1” through “F4” results in the same input to the operating system or application program. A compound key may be assigned to a response such as “yes”, “enter”, or “cancel”. In another embodiment, a group of keys could be assigned to a particular alphanumeric character. The alphanumeric keys could in this way be grouped into a reduced number of larger alphanumeric compound keys. A separate group of keys (e.g., the numeric keypad) may be used to toggle between different arrangements of these compound keys, so that all characters may be accessed. A representation of the keyboard illustrating the key groupings active at a particular time and the input corresponding to each grouping may be displayed on the computer's display screen. Alternatively, a template laid over the keyboard may be used to indicate the compound key groupings, particularly for applications in which the grouping does not change during the performance of a task. Although a number of the keys of the keyboard are programmed to input the same signal, the user is still presented with a bewildering array of small keys.

In co-pending Israel Application Number 177791 a simplified keyboard consisting of a small number of jumbo keys was disclosed. When placed over a regular QWERTY keyboard, the surround of the jumbo keys prevents keys of the QWERTY keyboard lying therebeneath from being depressed. If the jumbo keys themselves are depressed, the keystrokes are transmitted to the underlying keys and data entry to the computer is facilitated via the QWERTY keyboard lying thereunder. It is a particular feature of embodiments of the system described in Israel Application Number 177791, that the exact positioning of the jumbo keys with respect to the underlying QWERTY keyboard is not critical, since the jumbo keys could be calibrated via software means.

Despite its many advantages, the keyboard of Israel Application Number 177791 has several limitations. One of these is that typical embodiments thereof are incompatible with the reduced sized keyboards of portable computers such as laptops and notebook computers. This limitation is significant, since in most PCs, the keyboard is a separate module that is easily put to one side, enabling a specialist interface to be used in its stead. The alternative keyboard may be connected in parallel, or may interact over a wireless data link such as is generally used for remove computer keyboards and mice. Alternatively, the standard QWERTY keyboard of a PC may be easily disconnected to make room for an alternative keyboard or other simplified data input device, and reconnected after use. In contradistinction, the location of the keyboards of notebook or laptop computers are generally more rigidly fixed in relation to the screen, typically immediately in front of the screen, and although an alternative keyboard may be connected in parallel thereto via a USB or other port, or perhaps remotely, and possibly will override and thus disconnect the existing, integral QWERTY keyboard, nevertheless the QWERTY keyboard is there, in front of the screen, and liable to be damaged by the thumping of a child or disabled user of the simplified keyboard, and may be damaged by food or drink being spilled thereonto.

There is, therefore, a need for a simplified keyboard that is particularly appropriate for use by a child or disabled person, that is compatible with a laptop or notebook computer and which protects the keyboards thereof from damage, and the present invention addresses this need.

### SUMMARY OF THE INVENTION

It is an aim of the embodiments to provide an interface for a child or a physically challenged user to interact with a computer, particularly a notebook or laptop computer.

It is a further aim, that the interface protects the keyboard of the computer.

It is yet a further aim, that the interface is a simple mechanical device that is rugged.

It is still yet a further aim, that the interface may be retrofitted to an existing keyboard.

It is yet a further aim, that the interface is simplified, having a minimum number of keys.

In a first aspect, the present invention is directed to providing an interface for use with a portable computer, the interface having a plurality of jumbo buttons, each jumbo button for covering more than one key of an integral keyboard of the portable computer, the interface for covering the integral keyboard.

Typically, the portable computer is selected from the group comprising laptop computers and notebook computers.

Typically, the keyboard is a QWERTY keyboard.

Preferably the plurality of jumbo buttons is brightly colored.

Optionally and preferably the plurality of jumbo buttons is marked with easily recognized symbols.

Optionally the easily recognized symbols are selected from the list of letters, numbers, shapes and icons.

Typically the display is displayed on a monitor integral to the portable computer.

Typically the interface physically covers the keyboard of the portable computer from damage.

Optionally, the interface communicates with the portable computer via the keys of the integral keyboard.

Typically, the keyboard transmits depressions of the jumbo keys of the interface to the keys of the integral keyboard.

Optionally a software modification to the operation of the integral keyboard groups at least a first plurality of keys into at least one jumbo button such that pressure on any of said plurality of keys has an equivalent effect.

Additionally of alternatively, the interface communicates with the portable computer via a data cable.

Additionally of alternatively, the interface communicates with the portable computer via a cordless link.

Optionally, the interface covers the integral keyboard and prevents pressure from being applied to one or more keys of the integral keyboard, preventing the one or more keys from being depressed.

Alternatively, keys not associated with the at least one jumbo button are disabled by a software program, such that pressure thereon is not registered by the computer.

Preferably the interface is configured to interact in a virtual environment accessible via the Internet.

Most preferably, the keyboard automatically identifies itself to the virtual environment, thereby enabling a user to be recognized.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic isometric projection of a portable computer with the interface according to a first embodiment of the present invention fitted over the integral keyboard of the portable computer, and

FIG. 2 is an exploded view of the embodiment of FIG. 1.

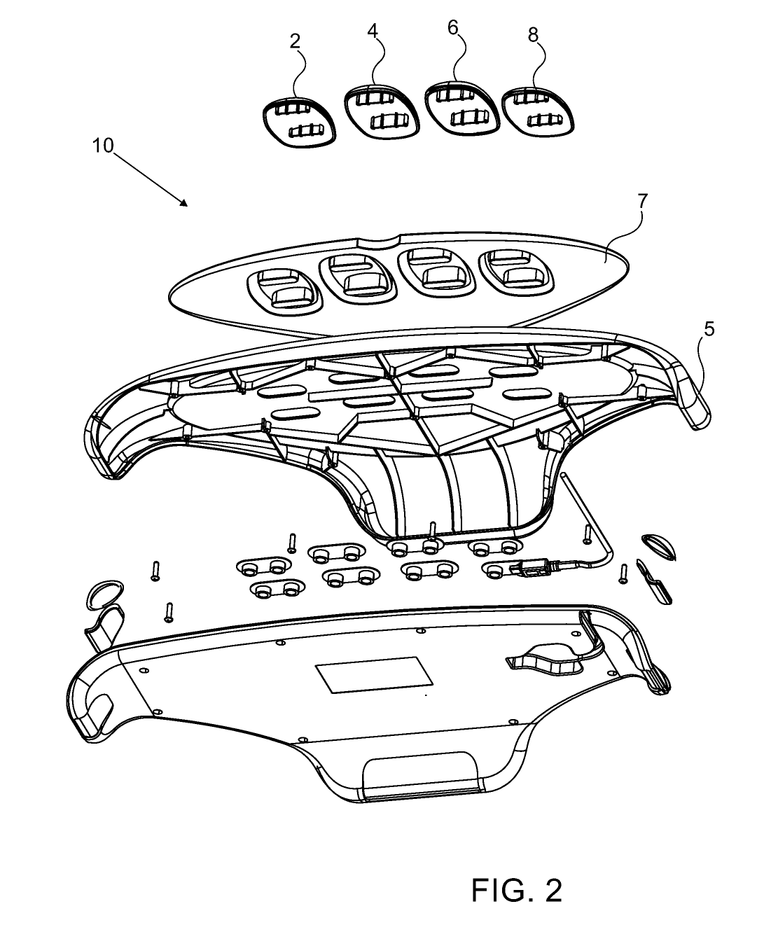

### DETAILED DESCRIPTION OF THE EMBODIMENTS

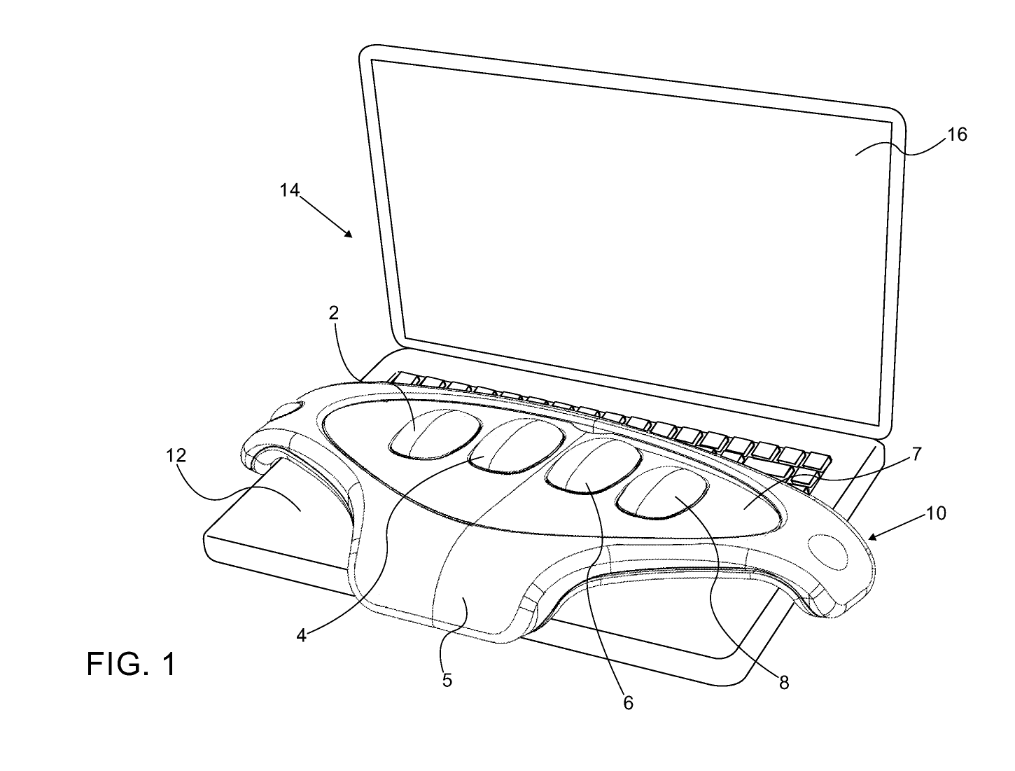

Referring now to FIG. 1, an interface 10 for retrofitting over the integral QWERTY keyboard 12 of a portable computer 14 is shown.

By portable computer 14, a computer having a dedicated integral keyboard 12 and a dedicated integral screen 16, such that the keyboard 12 and screen 16 are in close and rigid proximity of each other is intended.

Portable computers 14 in this context, include laptops and notebook type computers.

The difference between laptop and notebook computers is largely arbitrary, and it will be readily appreciated that desktop computers are themselves fairly portable. Thus the laptop/notebook computer, in this context, is a personal computer designed for mobile use, that includes an integral display and keyboard, and typically a pointing device (a touchpad, also known as a trackpad, and/or a pointing stick) and usually also includes speakers within the single unit. The portable computer is powered by mains electricity via an AC adapter, and can be used away from an outlet using a rechargeable battery. A laptop battery in new condition typically stores enough energy to run the laptop for three to five hours, depending on the computer usage, configuration and power management settings. When the laptop is plugged into the mains, the battery generally charges, whether or not the computer is running.

It will be noted that as portable computers have become smaller, lighter, and cheaper and as their screens have become larger and of better quality, laptops became very widely used for all purposes.

Generally, a full-size laptop computer is large enough to accommodate a keyboard with the minimum QWERTY key layout, which is at least 13.5 keys across that are each mounted on ¾″ centers, with some room at both ends for the case. Thus the measurement of at least 11 inches across has been suggested as the threshold for this class. The first laptops were the size of a standard U.S. “A size” notebook sheet of paper (8.5×11 inches), but later “A4-size” laptops were introduced, which were the width of a standard ISO 216 A4 sheet of paper (297 mm, or about 11.7 inches), and added a vertical column of keys to the right and included wider screens.

The term notebook: generally relates to a smaller, lighter, more portable laptop that is usually cheaper than a full-size laptop, but has fewer features and less computing power. Having smaller keyboards, the notebook can be more difficult to operate. There is however, no sharp line of demarcation between netbooks and inexpensive small laptops, and some 11.6″ models are marketed as netbooks. Since netbooks, compared to laptops, are quite small in size, CDs often cannot be used in these computers.

The term portable computer as used herein, also includes Tablet PCs and rugged engineered portable computers designed to operate in tough conditions and to be resistant to mechanical shocks, extreme temperatures, and wet and/or dusty environments.

The interface 10 includes a plurality of jumbo buttons 2, 4, 6, 8 fitted onto a base 5 such that each jumbo button 2, 4, 6, 8 covers more than one key of the QWERTY keyboard 12 thereunder. It is a particular feature of one embodiment of the present invention is that a small number of jumbo buttons 2 (4, 6, 8), in this case merely four buttons, are provided in a simplified interface 10 that serves as a keyboard that is easily operated by infants or the disabled.

The plurality of jumbo buttons 2 (4, 6, 8) may be brightly colored and may be marked with easily recognized symbols such as letters, numbers, shapes and icons. A base plate 5 of the interface 10 is provided. This may shield other keys of the integral keyboard 12 preventing their being accidentally depressed. Alternatively, these other keys may programmed (or deprogrammed), so as not to respond to depressions.

The base 10 has a base plate 5 that covers keys of the integral keyboard 12, typically preventing them from being depressed. The jumbo buttons 2 (4, 6, 8) may comprise a spring mechanism that facilitates their retraction to their raised position. Generally speaking, each jumbo button 2 (4, 6, 8) covers more than one key of the integral keyboard 12 thereunder.

Integral keyboards 12 for portable computers such as notebook computers and laptop computers are very similar, but the different models do vary somewhat. An interface 10 of the present invention will typically line up each jumbo button 2, 4, 6, 8, thereof with an array of keys of the integral keyboard 12 therebeneath. Optionally a larger array of keys therebeneath are programmed to respond in the same way, so that all keys of the integral keyboard 12 of the portable computer 14 actually under the jumbo button 2 (4, 6, 8) may be depressed by depression on the jumbo button 2 (4, 6, 8,) thereover, with other keys therearound being programmed to respond in the same way, but being protected from depression by the base plate 5 of the interface 10 thereover. Alternatively, once an interface 10 of the invention is affixed over the integral keyboard 12, the keys under the buttons 2 (4, 6, 8) may be programmed in response to a configuration procedure performed by the operator pushing on the jumbo buttons 2 (4, 6, 8). For example, this may be achieved by a child depressing the buttons 2 (4, 6, 8) in accordance with instructions provided on the screen 16 or via a speech synthesizer of the portable computer 12 to which the interface 10 is attached.

In a preferred embodiment, the jumbo keys 2, 4, 6, 8 and their immediate surrounds 7 are configured as an insert that is removable from the rigid base 5. In such embodiments, the immediate surrounds 7 may be removed from the rigid base 5 and placed onto any standard keyboard, such as that of a regular desktop computer, for example.

Depression of the jumbo keys 2, 4, 6, 8 is transmitted through the immediate surround 7 to the keyboard therebeneath. By calibration, the depressions of each of the jumbo buttons 2, 4, 6, 8, may be calibrated so that data may be input to the desktop computer via keystrokes transmitted via the jumbo keys 2, 4, 6, 8 to keyboard keys thereunder. The immediate surrounds 7 may be flexible and may transmit key strokes therethrough, but the calibration of the jumbo keys 2, 4, 6, 8 of the keyboard insert includes voiding key presses transmitted by the immediate surrounds 7, thereby providing a software solution. Alternatively, the keyboard surrounds 7 may be rigid and may engage the keyboard surrounds of the keyboard thereunder and may simply not transmit pressure thereupon to keys thereunder.

To facilitate use of the interface with an integral keyboard 12 and the insert with a regular QWERTY keyboard., some embodiments of the present invention also relates to a program for programming a QWERTY keyboard such that the more than one key of the QWERTY keyboard (regular or integral 12) interfaced by a specific jumbo button 2 of the interface 10 are programmed in parallel so that any of the keys covered by the same jumbo button 2 will provide an identical signal to the computer 14.

The software program may define a low sensitivity to key strokes, such that only conscious thumping of a jumbo button 2 on the interface 10 will register an input and only one single input is registered per thump.

Although described hereinabove mostly with regard to an interface 12 for a child, embodiments of the invention described herein may be embodied for users with various disabilities.

The number of jumbo buttons 2 (4, 6, 8) may vary somewhat between embodiments. For example the first embodiment as shown has four jumbo buttons 2 (4, 6, 8, 10)

In preferred embodiments, the interface 10 may fully cover the integral keyboard 12 and its surrounds, providing a large degree of protection thereto, from spillages and the like. In other embodiments the interface 10 covers only part of the integral keyboard 12.

Optionally, the interface 10 may be placed randomly over the keyboard (whether full size, independent, or integral keyboard 12) and is self-calibrating in that depressing a jumbo button 2 (4, 6, 8), alerts the software as to which keys of the keyboard are lying there-under. The underlying keys under each jumbo button 2, (4, 6, 8) are treated equivalently and assigned the functionality of the jumbo button jumbo button 2, (4, 6, 8). The effect of depressing keys that are not under any jumbo button jumbo button 2, (4, 6, 8) may be nullified by the software. This is particularly useful, if the interface 10 transmits forces through sections (e.g. 5, 7) not designated as keys jumbo button 2, (4, 6, 8), such as if fabricated from a relatively soft or flexible material such as Styrofoam, cardboard, a flexible matting material and the like.

The shape and structure of the interface 10, buttons jumbo button 2, (4, 6, 8) and any fixing means for attachment to a keyboard may vary considerably between embodiments. Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

One preferred application of the interface is to operate in a dedicated, virtual environment accessible over the Internet. Whether access is via a cable or remotely, in preferred embodiments, the interface has a unique identifier for identifying itself to such an environment. In this manner, a user with a dedicated interface can be recognized by the environment and greeted, or previous settings can be replicated.

In the claims, the word “comprise”, and variations thereof such as “comprises”, “comprising” and the like indicate that the components listed are included, but not generally to the exclusion of other components.

What is claimed is:

1. An interface for use with a portable computer, the interface having a plurality of jumbo buttons, each jumbo button for covering more than one key of an integral keyboard of the portable computer, the interface for covering the integral keyboard.

2. The interface of claim 1, wherein the portable computer is selected from the group comprising laptop computers and notebook computers.

3. The interface of claim 1, wherein the integral keyboard is a QWERTY keyboard.

4. The interface of claim 1, wherein the plurality of jumbo buttons are brightly colored.

5. The interface of claim 1, wherein the plurality of jumbo buttons is marked with easily recognized symbols.

6. The interface of claim 5, wherein the easily recognized symbols are selected from the list of letters, numbers, shapes and icons.

7. The interface of claim 1, wherein the display is displayable on a monitor integral to the portable computer.

8. The interface of claim 1, wherein the interface physically covers the keyboard of the portable computer from damage.

9. The interface of claim 1, wherein the interface communicates with the portable computer via the keys of the integral keyboard.

10. The interface of claim 1, wherein, the keyboard transmits depressions of the jumbo keys of the interface to the keys of the integral keyboard.

11. The interface of claim 1, wherein a software modification to the operation of the integral keyboard groups at least a first plurality of keys into at least one jumbo button such that pressure on any of said plurality of keys has an equivalent effect.

12. The interface of claim 1, wherein the interface communicates with the portable computer via a data cable.

13. The interface of claim 1, wherein the interface communicates with the portable computer via a cordless link.

14. The interface of claim 1, wherein covers the integral keyboard and prevents pressure from being applied to one or more keys of the integral keyboard, preventing the one or more keys from being depressed.

15. The interface of claim 1, wherein keys not associated with the at least one jumbo button are disabled by a software program, such that pressure thereon is not registered by the computer.

16. The Interface of claim 1 wherein configured to interact in a virtual environment accessible via the Internet.

17. The interface of claim 16, configured to automatically identify itself to the virtual environment.
